(19) United States
(12) Patent Application Publication
(10) Pub. No.: US 2017/0151809 A1
(43) Pub. Date: Jun. 1, 2017

(54) THERMAL HEAD AND THERMAL PRINTER

(71) Applicant: KYOCERA Corporation, Kyoto-shi, Kyoto (JP)

(72) Inventors: Masafumi HIRAYAMA, Kyoto-shi (JP); Yuuna OOKUBO, Kyoto-shi (JP); Yasumitsu YAMAMOTO, Kyoto-shi (JP); Youichi MOTO, Kyoto-shi (JP); Yui TANAKA, Kyoto-shi (JP); Hisatoshi TAKADA, Kyoto-shi (JP)

(73) Assignee: KYOCERA Corporation, Kyoto-shi, Kyoto (JP)

(21) Appl. No.: 15/321,089

(22) PCT Filed: Jun. 18, 2015
(86) PCT No.: PCT/JP2015/067620

§ 371 Date: Dec. 21, 2016

(30) Foreign Application Priority Data
Jun. 24, 2014 (JP) 2014-129278
Jul. 18, 2014 (JP) 2014-147899

(51) Int. Cl. B41J 2/335

(52) U.S. Cl. CPC B41J 2/33595

(57) ABSTRACT

A thermal head includes a substrate; a heat generating section disposed on the substrate; an electrode which is disposed on the substrate and is electrically connected to the heat generating section; and a connector including a fixing ping electrically connected to the electrode, a movable pin which holds the substrate between the movable pin and the fixing pin, and a connection pin which connects the fixing pin and the movable pin. The movable pin includes a movable section which is bent or curved and a contact section making contact with the substrate. The movable pin is disposed so as to protrude from the connection pin beyond the fixing pin. The contact section is located closer to a connection pin side than a tip end of the fixing pin.

### TECHNICAL FIELD

The present invention relates to a thermal head and a thermal printer.

### BACKGROUND ART

Various kinds of thermal heads have been proposed conventionally as printing devices for facsimiles, video printers, etc. For example, there is known a thermal head including: a substrate, a plurality of heat generating sections disposed on the substrate, electrodes which are disposed on the substrate and are electrically connected to the heat generating sections, and a connector which holds the substrate between a base layer made of an insulating material and conductors embedded in the base layer (for example, refer to FIG. 3 in Patent Literature 1). Furthermore, in the thermal head described in Patent Literature 1, the substrate is inserted between the base layer made of an insulating material and the conductors embedded in the base layer, whereby the electrodes are electrically connected to the connector.

### CITATION LIST

### Patent Literature

Patent Literature 1: Japanese Unexamined Patent Publication JP-A 6-203930(1994)

### SUMMARY OF INVENTION

### Technical Problem

However, since the connector is fitted on the substrate in a state where the conductors embedded in the base layer are made contact with the electrodes in the above-mentioned thermal head, there is a danger that the electrodes may be broken.

### Solution to Problem

A thermal head according to an embodiment of the invention includes a substrate; a heat generating section disposed on the substrate; an electrode which is disposed on the substrate and is electrically connected to the heat generating section; and a connector comprising a fixing pin electrically connected to the electrode, a movable pin which holds the substrate between the movable pin and the fixing pin, and a connection pin which connects the fixing pin to the movable pin. Furthermore, the movable pin comprises a movable section which is bent or curved and a contact section making contact with the substrate. Moreover, the movable pin is disposed so as to protrude from the connection pin beyond the fixing pin. Furthermore, the contact section is located closer to a connection pin side than a tip end of the fixing pin.

In addition, a thermal printer according to an embodiment of the invention includes the above-mentioned thermal head, a conveying mechanism which conveys a recording medium onto the heat generating section, and a platen roller which presses the recording medium against the heat generating section.

Furthermore, a method for manufacturing the thermal head according to an embodiment of the invention relates to a method for manufacturing a thermal head including a substrate; heat generating sections disposed on the substrate; an electrode which is disposed on the substrate and is electrically connected to the heat generating section; and a connector comprising a fixing pin electrically connected to the electrode, a movable pin which holds the substrate between the movable pin and the fixing pin, and a connection pin which connects the fixing pin to the movable pin; the movable pin comprising a movable section which is bent or curved and a contact section making contact with the substrate; the movable pin being disposed so as to protrude from the connection pin beyond the fixing pin; and the contact section being located closer to a connection pin side than a tip end of the fixing pin. Furthermore, the method comprises, while pressing the movable pin downwardly, inserting the substrate between the fixing pin and the movable pin and releasing a downwardly pressing force, and thereby electrically connecting the electrode and the fixing pin.

### Advantageous Effects of Invention

It is possible to reduce the possibility that the electrodes may be broken.

### BRIEF DESCRIPTION OF DRAWINGS

FIG. 1 is a plan view showing a thermal head according to a first embodiment;

FIG. 2 is a cross-sectional view taken along the line I-I of FIG. 1;

FIG. 3 shows a connector constituting the thermal head according to the first embodiment, wherein FIG. 3(a) is a perspective view, and FIG. 3(b) is a partially enlarged perspective view;

FIG. 4 shows a connector constituting the thermal head according to the first embodiment, wherein FIG. 4(a) is a front view, FIG. 4(b) is a rear view, and FIG. 4(c) is a perspective view showing a connector pin constituting the connector;

FIG. 5 is an enlarged view showing the vicinity of the connector of the thermal head according to the first embodiment, wherein FIG. 5(a) is a plan view, and FIG. 5(b) is a bottom view;

FIG. 6(a) is an enlarged side view showing the vicinity of the connector of the thermal head according to the first embodiment, and FIG. 6(b) is a cross-sectional view taken along the line II-II of FIG. 5(a);

FIGS. 7(a) to 7(c) are cross-sectional views showing a process for joining the connector to a substrate;

FIG. 8 is a schematic view showing a thermal printer according to the first embodiment;

FIG. 9 is a side view showing a thermal head according to a second embodiment;

FIG. 10 shows a thermal head according to a third embodiment; FIG. 10(a) is a cross-sectional view, and FIG. 10(b) is a perspective view showing a connector pin;

FIG. 11 is an enlarged view showing the vicinity of a connector of a thermal head according to a fourth embodiment, wherein FIG. 11(a) is a plan view, and FIG. 11(b) is a bottom view;

FIG. 12(a) is a front view showing a connector constituting the thermal head according to the fourth embodiment; and FIG. 12(b) is a cross-sectional view taken along the line III-III of FIG. 11(a);

FIG. 13 is an enlarged view showing the vicinity of a connector of a thermal head according to a fifth embodiment, wherein FIG. 13(a) is a plan view, and FIG. 13(b) is a bottom view;

FIG. 14 shows the thermal head of FIG. 13, wherein FIG. 14(a) is a side view, and FIG. 14(b) is a cross-sectional view taken along the line IV-IV of FIG. 13(a); and

FIG. 15 shows a thermal head according to a sixth embodiment, wherein FIG. 15(a) is a side view, and FIG. 15(b) is a cross-sectional view.

### DESCRIPTION OF EMBODIMENTS

### First Embodiment

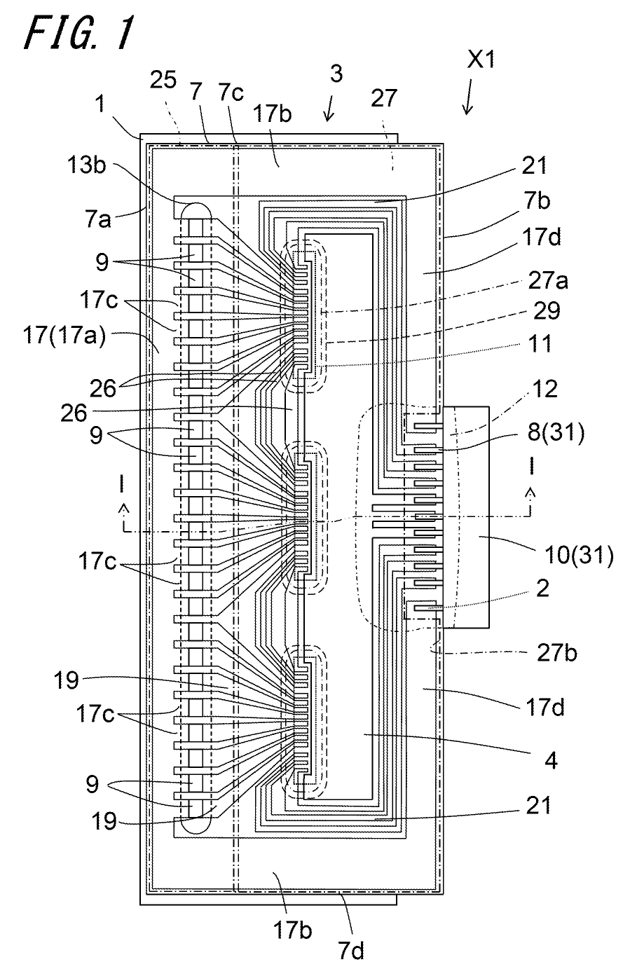

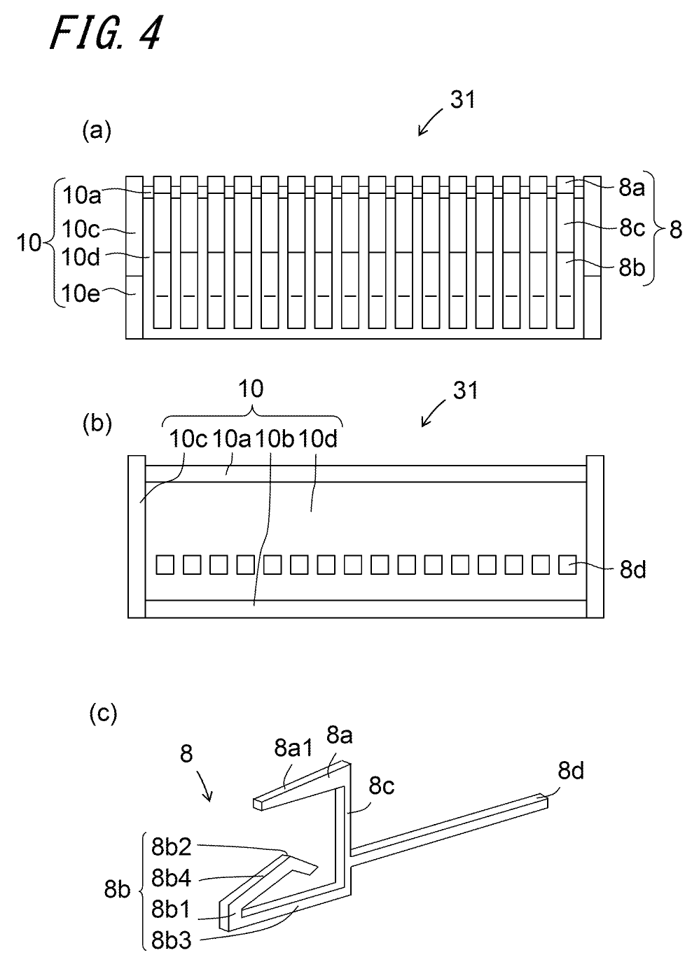

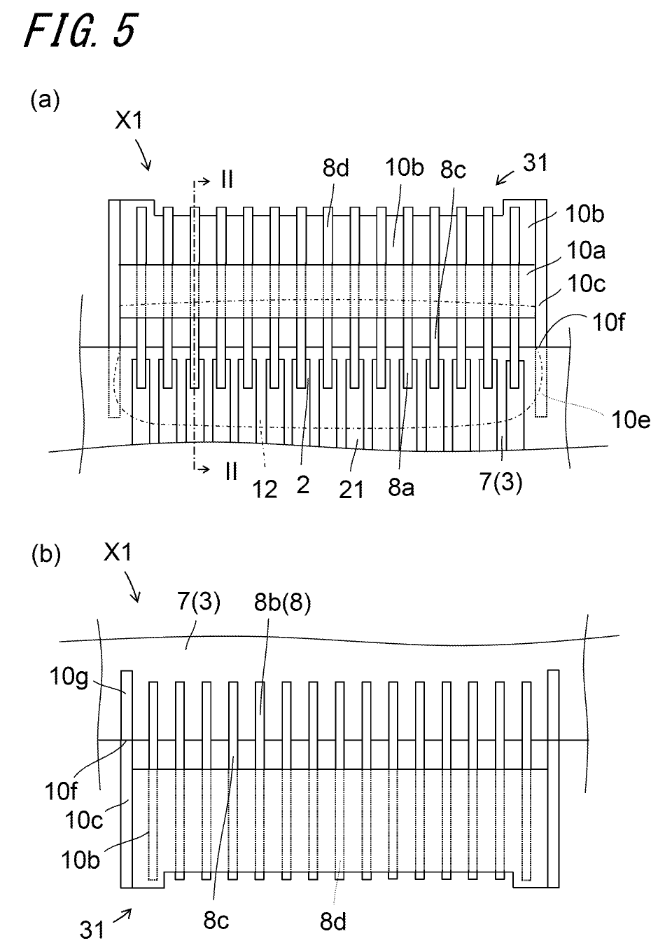

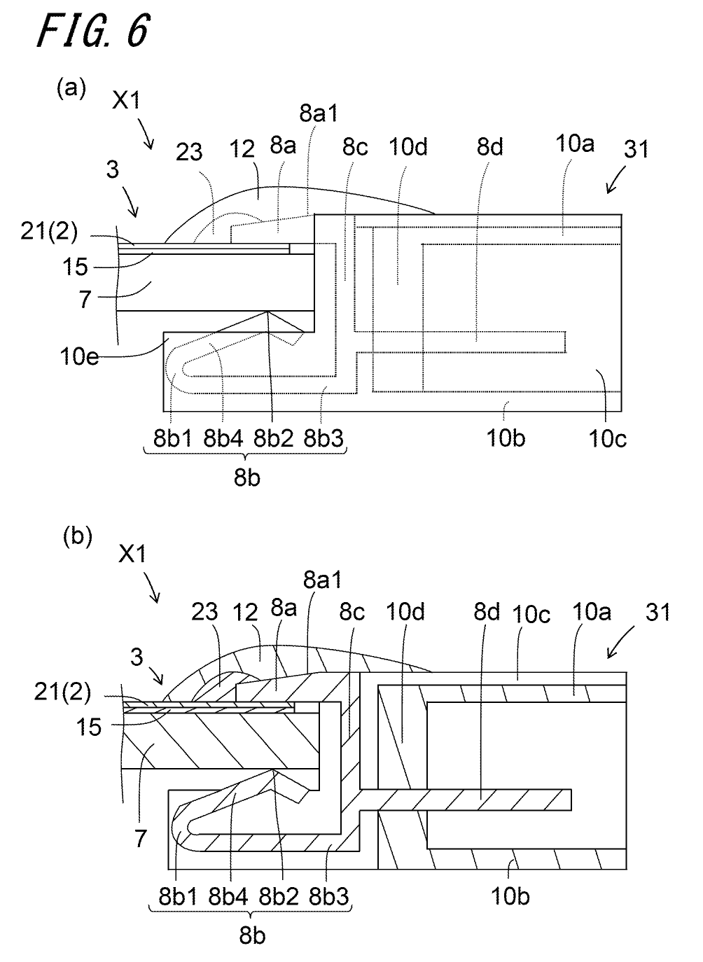

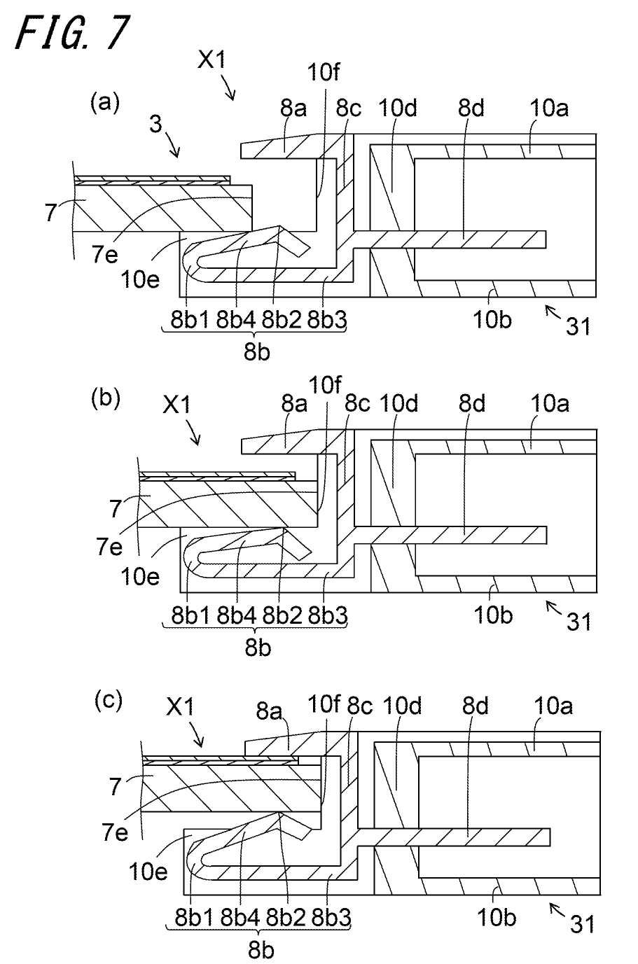

A thermal head X1 will be described below referring to FIGS. 1 to 7. In FIG. 1, a protection layer 25, a covering layer 27 and a covering member 12 are indicated by dashed-dotted lines for simplification. Furthermore, in FIG. 5(a), the covering member 12 is indicated by a dashed-dotted line for simplification. Moreover, in FIGS. 6 and 7, the protection layer 25 and the covering layer 27 are omitted.

The thermal head X1 includes a radiator 1, a head base body 3 disposed on the radiator 1, and a connector 31 connected to the head base body 3.

The radiator 1 has a rectangular parallelepiped shape and is made of, for example, a metal material such as copper, iron or aluminum. The radiator 1 has a function of radiating heat which does not contribute to printing from the heat generated by the heat generating sections 9 of the head base body 3. In addition, the head base body 3 is bonded to the upper face of the radiator 1 with, for example, a double-sided tape or an adhesive (not shown).

The head base body 3 is formed into a rectangular shape in a plan view thereof, and various members constituting the thermal head X1 are disposed on the substrate 7 of the head base body 3. The head base body 3 has a function of performing printing on a recording medium (not shown) according to an electrical signal supplied from the outside.

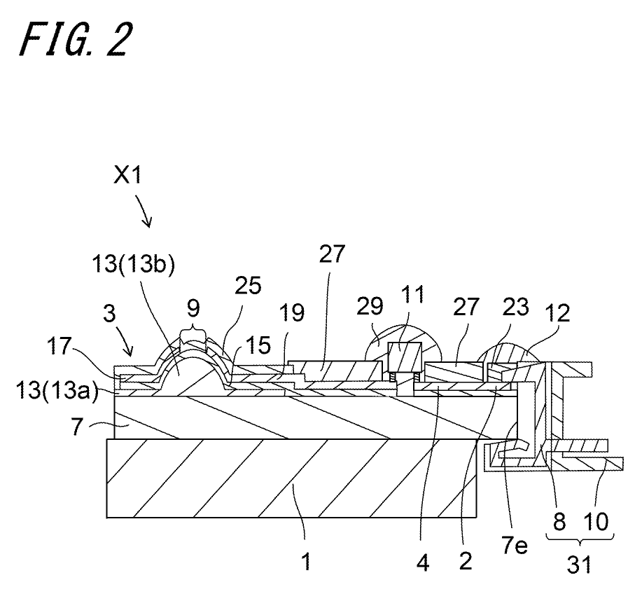

The connector 31 includes a plurality of connector pins 8 and a housing 10 which accommodates the plurality of connector pins 8 as shown in FIG. 2. One sides of the plurality of connector pins 8 are exposed to the outside of the housing 10, and the other sides thereof are accommodated inside the housing 10. The plurality of connector pins 8 has a function of ensuring electrical conduction between the various kinds of electrodes of the head base body 3 and power sources disposed outside the housing, and the plurality of connector pins 8 are electrically independent of one another. The housing 10 is not necessarily required.

The respective members constituting the head base body 3 will be described below.

The substrate 7 is disposed on the radiator 1 and has a rectangular shape in a plan view. Hence, the substrate 7 has one long side 7a and the other long side 7b and also has one short side 7c and the other short side 7d. Furthermore, the substrate 7 has a side face 7e on the side of the other long side 7b. The substrate 7 is made of, for example, an electrically insulating material such as alumina ceramics, or a semiconductor material such as single-crystal silicon.

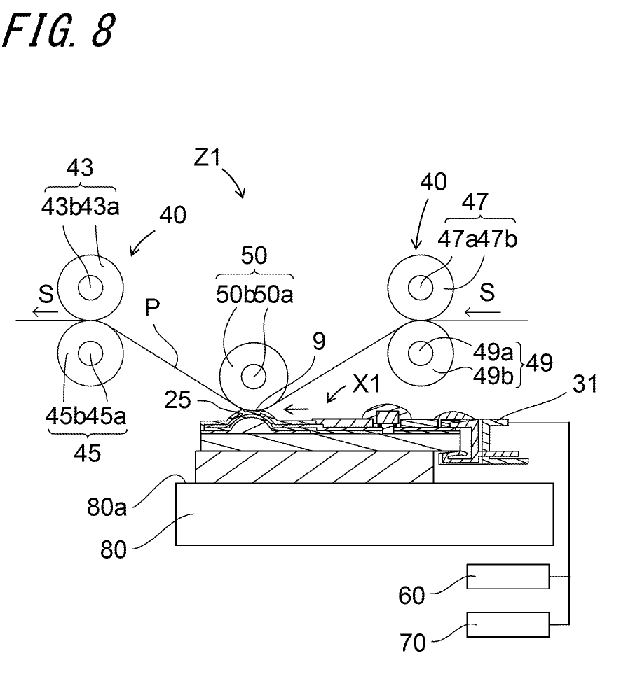

A heat storage layer 13 is formed on the upper face of the substrate 7. The heat storage layer 13 includes a base section 13a is formed on the left half of the upper face of the substrate 7. Furthermore, the base section 13a is disposed close to the heat generating sections 9 and disposed below the protection layer 25 described later. The protruding section 13b extends in a belt shape along the arrangement direction of the plurality of heat generating sections 9 and has a substantially semielliptical shape in cross section. Moreover, the protruding section 13b has a function of properly pressing a recording medium P (see FIG. 8) on which printing is performed, against the protection layer 25 formed on the heat generating sections 9.

The heat storage layer 13 is made of glass having a low thermal conductivity and temporarily stores part of the heat generated at the heat generating sections 9. Hence, the heat storage layer 13 can shorten the time required to raise the temperature of the heat generating sections 9 and has a function of raising the thermal response characteristic of the thermal head X1. The heat storage layer 13 is formed, for example, by applying a predetermined glass paste obtained by mixing glass powder with an appropriate organic solvent, onto the upper face of the substrate 7 using a known screen printing or otherwise and by firing the glass paste.

An electric resistance layer 15 is disposed on the upper face of the heat storage layer 13, and connection terminals 2, a ground electrode 4, a common electrode 17, individual electrodes 19, IC-connector connection electrodes 21 and IC-IC connection electrodes 26 are disposed on the electric resistance layer 15. The electric resistance layer 15 is patterned into a shape identical with the shape formed by the connection terminals 2, the ground electrode 4, the common electrode 17, the individual electrodes 19, the IC-connector connection electrodes and the IC-IC connection electrodes 28, and the electric resistance layer 15 has exposed regions that are exposed in the areas between the common electrode 17 and the individual electrodes 19. The exposed regions of the electric resistance layer 15 are disposed in rows on the protruding section 13b of the heat storage layer 13, whereby the respective exposed regions constitute the heat generating sections 9.

Although the plurality of heat generating sections 9 is shown simply in FIG. 1 for convenience of explanation, the plurality of heat generating sections 9 are disposed at a density of, for example, 100 to 2400 dpi (dots per inch). The electric resistance layer 15 is made of, for example, a material having a relatively high electric resistance, such as a TaN-based, based, TaSiO-based, TaSiNO-based, TaSiO-based or TiSiCO-based material. Hence, when voltage is applied to the heat generating sections 9, the heat generating sections 9 generate heat by Joule heat.

As shown in FIGS. 1 and 2, the connection terminals 2, the ground electrode 4, the common electrode 17, the plurality of individual electrodes 19, the IC-connector connection electrodes and the IC-IC connection electrodes 26 are disposed on the upper face of the electric resistance layer 15. The connection terminals 2, the ground electrode 4, the common electrode 17, the individual electrodes 19, the IC-connector connection electrodes 21 and the IC-IC connection electrodes 26 are made of conductive materials, for example, one metal of aluminum, gold, silver and copper, or an alloy of these metals.

The common electrode 17 includes main wiring sections 17a and 17d, auxiliary wiring sections 17b and lead sections 17c. The main wiring section 17a extends along the one long side 7a of the substrate 7. The auxiliary wiring sections 17b extend along the one short side 7c and the other short side 7d of the substrate 7, respectively. The lead sections 17c extend individually toward the respective heat generating sections 9 from the main wiring section 17a. The main wiring section 17d extends along the other long side 7b of the substrate 7.

The common electrode 17 electrically connects the plurality of heat generating sections 9 to the connector 31. The main wiring section 17a may be formed of a thick electrode section (not shown) thicker than the other portion of the common electrode 17 to lower the electric resistance value of the main wiring section 17a. In that case, the electric capacity of the main wiring section 17a can be made larger.

The plurality of individual electrodes 19 electrically connect the heat generating sections 9 to drive ICs 11. Furthermore, the individual electrodes 19 divide the plurality of heat generating sections 9 into a plurality of groups and electrically connect the heat generating sections 9 of the respective groups to the drive ICs 11 disposed corresponding to the respective groups.

The plurality of IC-connector connection electrodes 21 electrically connect the drive ICs 11 to the connector 31. The plurality of IC-connector connection electrodes 21 connected to the respective drive ICs 11 is formed of a plurality of wires having different functions.

The ground electrode 4 is disposed so as to surround the individual electrodes 19, the IC-connector connection electrodes and the main wiring section 17d of the common electrode 17 and has a wide area. The potential of the ground electrode 4 is held at a ground potential of 0 to 1 V.

The connection terminals 2 are disposed on the other long side 7b of the substrate 7 so as to connect the common electrode 17, the individual electrodes 19, the IC-connector connection electrodes 21 and the ground electrode 4 to the connector 31. The connection terminals 2 are disposed corresponding to the connector pins 8, and when connected to the connector 31, the connection terminals 2 are electrically connected to the connector pins 8 so as to be electrically independent of one another.

The plurality of IC-IC connection electrodes 26 electrically connect the drive ICs 11 adjacent to each other. The plurality of IC-IC connection electrodes 26 is respectively disposed corresponding to the IC-connector connection electrodes 21, thereby transmitting various kinds of signals to the drive ICs 11 adjacent to each other.

The electric resistance layer 15, the connection terminals 2, the common electrode 17, the individual electrodes 19, the ground electrode 4, the IC-connector connection electrodes 21 and the IC-IC connection electrodes 26 described above are formed, for example, by sequentially laminating the material layers constituting the respective electrodes on the heat storage layer 13 by a known thin-film forming technology such as a sputtering method, and then processing the laminated body into a predetermined pattern by a known photoetching method or otherwise. The connection terminals 2, the common electrode 17, the individual electrodes 19, the ground electrode 4, the IC-connector connection electrodes 21 and the IC-IC connection electrodes 26 can be formed in the same process simultaneously.

The drive ICs 11 are disposed corresponding to the respective groups of the plurality of heat generating sections 9 and are connected to the other end portions of the individual electrodes 19 and the one end portions of the IC-connector connection electrodes 21 as shown in FIG. 1. The drive IC 11 has a function of controlling the conduction states of the respective heat generating sections 9. A switching member having a plurality of switching elements inside may merely be used as the drive IC 11.

The drive IC 11 is sealed with a hard coat 29 formed of a resin such as an epoxy resin or a silicone resin, in a state of being connected to the individual electrodes 19, the IC-IC connection electrodes 26 and the IC-connector connection electrodes 21.

As shown in FIGS. 1 and 2, the protection layer 25 which covers the heat generating sections 9, part of the common electrode 17 and parts of the individual electrodes 19 is formed on the heat storage layer 13 which is formed on the upper face of the substrate 7.

The protection layer 25 protects covered regions of the heat generating sections 9, the common electrode 17 and the individual electrodes 19 from corrosion caused by the deposition of moisture or the like contained in the air or from abrasion caused by the contact with a recording medium on which printing is performed. The protection layer 25 can be formed by using SiN, SiO₂, SiON, SiC, diamond-like carbon or the like, and the protection layer 25 may be formed of a single layer or may be formed by laminating these layers. The protection layer 25 described above can be manufactured by using a thin-film forming technology such as a sputtering method, or a thick-film forming technology such as screen printing.

In addition, as shown in FIGS. 1 and 2, the covering layer which partially covers the common electrode 17, the individual electrodes 19 and the IC-connector connection electrodes 21 is disposed on the substrate 7. The covering layer 27 protects the covered regions of the common electrode 17, the individual electrodes 19, the IC-IC connection electrodes 26 and the IC-connector connection electrodes 21 from oxidation caused by the contact with the air or from corrosion caused by the deposition of moisture or the like contained in the air. The covering layer 27 can be, for example, formed of a resin material such as an epoxy resin or a polyimide resin, by using a thick-film forming technology such as screen printing.

In the covering layer 27, openings 27a are formed so that the individual electrodes 19, the IC-IC connection electrodes 26 and the IC-connector connection electrodes 21 to be connected to the drive ICs 11 are exposed therefrom. Furthermore, the wires exposed from the openings 27a are connected to the drive ICs 11. Moreover, the covering layer 27 is provided with an opening 27b on the side of the other long side 7b of the substrate 7 so that the connection terminals 2 are exposed therefrom. The connection terminals 2 exposed from the opening 27b are electrically connected to the connector pins 8.

The connector 31 is fixed to the head base body 3 using the connector pins 8, a conductive joining material 23 and the covering member 12. As shown in FIGS. 1 and 2, the connector pins 8 are disposed on the connection terminal 2 of the ground electrode 4 and on the connection terminals 2 of the IC-connector connection electrodes 21. As shown in FIG. 2, the connection terminals 2 are electrically connected to the connector pins 8 by the conductive joining material 23.

Solder or an anisotropic conductive adhesive formed of conductive particles mixed in an electric insulation resin can be taken as an example of the conductive joining material 23. In this embodiment, solder is used for explanation. The connector pins 8 are electrically connected to the connection terminals 2 by covering the connector pins 8 with the conductive joining material 23. A plated layer (not shown) which is plated with Ni, Au or Pd may be disposed between the conductive joining material and the connection terminals 2. However, the conductive joining material 23 may not be necessarily required.

The covering member 12 is disposed so that the connection terminals 2 and fixing pins 8a are not exposed to the outside, and can be formed of, for example, an epoxy-based thermosetting resin, an ultraviolet curing resin or a visible light curing resin.

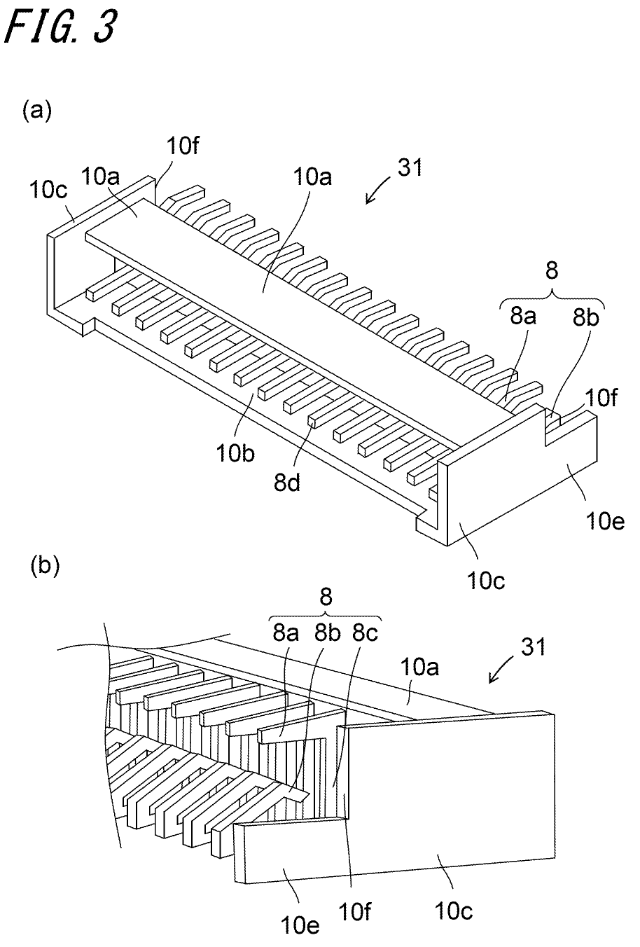

As shown in FIGS. 3 to 7, the connector 31 includes the plurality of connector pins 8 and the housing 10 which accommodates the plurality of connector pins 8.

The connector pin 8 includes the fixing pin 8a, a movable pin 8b, a connection pin 8c and an extraction pin 8d. The fixing pin 8a and the movable pin 8b of the connector pin 8 are connected by the connection pin 8c, and the extraction pin 8d is extracted from the connection pin 8c. Hence, the fixing pin 8a, the movable pin 8b, the connection pin 8c and the extraction pin 8d are formed integrally. The plurality of connector pins 8 is arranged at intervals along the main scanning direction thereof. The connector pins 8 are mutually separated, and the adjacent connector pins 8 are electrically insulated from each other.

The fixing pin 8a is disposed above the substrate 7 of the head base body 3 and disposed on the connection terminal 2. The movable pin 8b is disposed below the substrate 7 of the head base body 3, and the substrate 7 is held between the fixing pin 8a and the movable pin 8b. The movable pin 8b is disposed so as to protrude from the connection pin 8c beyond the fixing pin 8a.

The connection pin 8c connects the fixing pin 8a to the movable pin 8b and is disposed so as to extend in the thickness direction of the substrate 7. The extraction pin 8d is extracted in a direction away from the head base body 3 and joined to the housing 10. The connector 32 and the head base body 3 are electrically and mechanically joined to each other by inserting the head base body 3 between the fixing pins 8a and the movable pins 8b.

The thickness of a portion of the fixing pin 8a on the side close to the connection pin 8c is made larger than that the portion of the fixing pin 8a on the side away from the connection pin 8c. Hence, the thickness of the fixing pin 8a becomes gradually larger as the fixing pin 8a becomes closer to the connection pin 8c. For this reason, the fixing pin 8a has an inclined region 8a1 whose thickness becomes larger toward the connection pin 8c. Furthermore, the lower face of the fixing pin 8a is formed into a flat shape and disposed on the connection terminal 2. Hence, the connection area between the connection terminal 2 and the fixing pin 8a can be increased, and the electrical reliability of the thermal head X1 can be improved.

The movable pin 8b includes a movable section 8b1, a contact section 8b2, a first extension section 8b3 and a second extension section 8b4. The movable section 8b1 is formed into a bent shape and can be deformed elastically when the substrate 7 is inserted. However, the movable section 8b1 may be formed into a curved shape.

The contact section 8b2 is disposed so as to make contact with the lower face of the substrate 7, and the substrate 7 is held between the fixing pin 8a and the contact section 8b2. The first extension section 8b3 extends from the connection pin 8c toward the substrate 7 and is connected to the movable section 8b1. The second extension section 8b4 extends from the movable section 8b1 toward the connection pin 8c and is connected to the contact section 8b2. The contact section 8b2 is located closer to the connection pin 8c side than on the tip end of the fixing pin 8a, and the contact section 8b2 is disposed below the fixing pin 8a.

The movable section 8b1, the contact section 8b2, the first extension section 8b3 and the second extension section 8b4 of the movable pin 8b are formed integrally. In other words, the movable pin 8b is configured so as to extend from the connection pin 8c toward the substrate 7 and then so as to be bent at the movable pin 8b and to extend toward the connection pin 8c while being inclined. As a result, the movable pin 8b is formed so as to be elastically deformable in the thickness direction of the substrate 7.

The connection pin 8c connects the fixing pin 8a to the movable pin 8b and is disposed so as to extend in the thickness direction of the substrate 7. The extraction pin 8d is connected to the connection pin 8c, and when a cable (not shown) is connected to the extraction pin 8d from the outside, voltage is supplied to the thermal head X1.

Since the connector pin 8 requires conductivity, the connector pin 8 can be made of a metal or an alloy.

The housing 10 is formed into a box shape and has a function of accommodating the respective connector pins 8 in a state where the connector pins are electrically independent of one another. A socket connected to a cable is inserted from the outside into the opening portion of the housing 10, and electricity is supplied to the head base body 3 by connecting/disconnecting a cable or the like dispsoed externally.

The housing 10 includes an upper wall 10a, a lower wall 10b, side walls 10c, a front wall 10d, support sections 10e and positioning sections 10f. An opening portion is formed on the extraction pin 8d side of the connector pin 8 by the upper wall 10a, the lower wall 10b, the side walls 10c and the front wall 10d of the housing 10.

The support section 10e is disposed in a state of protruding from the side wall 10c toward the lower side of the substrate 7, and the support section 10e is disposed in a state of being separated from the substrate 7. In addition, the support section 10e protrudes from the housing 10 beyond the connector pin 8.

The positioning sections 10f have a function of positioning the inserted head base body 3, and are disposed closer to the substrate 7 than the connection pins 8c of the connector pins 8. Since the housing 10 includes the positioning sections 10f, the head base body 3 is configured so as not to abut on the connection pins 8c of the connector pins 8, whereby the possibility that the connection pins 8c may be broken due to bending or the like can be reduced.

In the case of the conventional connector, the movable pins thereof are disposed on the upper side of the substrate, and when the substrate is inserted into the connector, there is a possibility that the connection terminals disposed on the upper face of the substrate may wear and be broken and that the electrical connection between the head base body and the connector may be cut off.

On the other hand, since the movable pins 8b protrude beyond the fixing pins 8a in the thermal head X1, when the substrate 7 is inserted into the connector 31, the substrate 7 makes contact with the movable pins 8b earlier than the fixing pins 8a. Hence, the movable pins 8b are deformed downwardly, whereby the substrate 7 can be inserted in a state where a clearance is formed between the fixing pins 8a and the substrate 7. As a result, it is possible to reduce the possibility that the connection terminals 2 may make contact with the fixing pins 8a and may wear. For this reason, it is possible to reduce the possibility that the connection terminals 2 may be broken by the fixing pins 8a and to ensure the reliability of the electrical connection between the thermal head X1 and the outside.

Furthermore, the contact section 8b2 is located closer to the connection pin 8c side than the tip end of the fixing pin 8a, whereby the contact section 8b2 operates so as to cause the substrate 7 to abut on the lower face of the fixing pin 8a. Hence, it is possible to reduce the possibility that a rotational moment in the thickness direction of the substrate 7 may be generated, and to reduce the possibility that the substrate 7 may be rotated.

Still further, since the recording medium P (see FIG. 8) is transferred onto the connector 31 in the thermal head X1, the height of the covering member 12 is preferably low so that the covering member 12 does not make contact with the recording medium P.

In this respect, in the thermal head X1, the fixing pins 8a are disposed on the upper face side of the substrate 7 on which the heat generating sections 9 are disposed, and the movable pins 8b are disposed on the lower side of the substrate 7, whereby it is possible to reduce the possibility that the connection terminals 2 may be broken without making the height of the thermal head X1 on the upper face side of the substrate 7 large.

The fixing pin 8a includes the inclined region 8a1 whose thickness becomes larger toward the connection pin 8c. Hence, the rigidity of the fixing pin 8a becomes higher toward the connection pin 8c, whereby it is possible to lower the rigidity of the end portion of the fixing pin 8a to which the substrate 7 is inserted and to enhance the rigidity of the joining portion between the fixing pin 8a and the connection pin 8c. For this reason, the substrate 7 can be easily inserted between the fixing pins 8a and the movable pins 8b, and it is possible to reduce the possibility that the connector pins 8a may be deformed when the substrate 7 abuts on the housing 10.

The upper end of the fixing pin 8a is located below the highest portion of the housing 10. Hence, it is possible to lower the height of the covering member 12 disposed on the fixing pin 8a, whereby it is possible to reduce the possibility that the covering member 12 may make contact with the recording medium P (see FIG. 8) to be transferred over the substrate 7. Consequently, it is possible to reduce the possibility that the recording medium P may be damaged and that the connector 31 may be displaced.

In the case where part of the extraction pin 8d is joined to the front wall 10d of the housing 10 at a position below the contact section 8b2, when a cable (not shown) is connected to the housing 10, an external force may be generated in the housing 10 downward in the thickness direction of the substrate in some cases. In such a case, since the fixing pin 8a is fixed, a rotational moment is generated about the connection section of the fixing pin 8a and the connection terminal 2, and the movable pin 8b is deformed upwardly about the joining section between the first extension section 8b3 and the connection pin 8c.

Even in that case, since the movable section 8b1 of the movable pin 8b is deformed, an upwardly external force is less prone to be generated in the substrate 7. As a result, stress is suppressed from being generated between the connection terminal 2 and the fixing pin 8a, whereby it is possible to improve the reliability of the electrical connection between the thermal head X1 and the outside.

The joining between the head base body 3 and the connector 31 will be described below referring to FIG. 7.

The substrate 7 on which the respective members constituting the head base body 3 are formed, and the connector 31 are prepared. At this time, the conductive joining material (see FIG. 2), the covering member 12 (see FIG. 2) and the hard coat 29 (see FIG. 2) are not formed on the substrate 7.

Next, the head base body 3 is inserted in a space between the fixing pins 8a and the movable pins 8b. At the time, as shown in FIG. 7(a), the substrate 7 is inserted while pressing the movable pins 8b downwardly so that a clearance is generated between the fixing pins 8a and the substrate 7. Since the substrate 7 is inserted in a state where the lower face of the substrate 7 makes contact with the support sections 10e of the housing 10, it is possible to reduce the possibility that the movable pins 8b may be deformed excessively.

Next, as shown in FIG. 7(b), the end face 7e of the substrate 7 abuts on the positioning sections 10f of the housing 10. As a result, the head base body 3 can be positioned with respect to the connector 31.

Next, the downwardly pressing force applied to the movable pins 8b is released. Hence, the movable pins 8b are deformed upwardly, and the substrate 7 is pressed upwardly. Furthermore, since the substrate 7 displaced upwardly makes contact with the fixing pins 8a, whereby the substrate 7 is joined to the connector 31 and held between the fixing pins 8a and the movable pins 8b as shown in FIG. 7(c).

In the thermal head X1, the connection terminals 2 can be electrically connected to the fixing pins 8a by inserting the substrate 7 between the fixing pins 8a and the movable pins 8b while pressing the movable pins 8b downwardly and then by releasing the downwardly pressing force as described above. As a result, it is possible to reduce the possibility that the connection terminals 2 may be shaved by the fixing pins 8a and to ensure the electrical connection between the thermal head X1 and the outside.

Next, the conductive joining material 23 is applied to the respective fixing pins 8a by printing and then reflowed. As a result, the connector 31 and the substrate 7 are electrically connected and mechanically joined firmly by the conductive joining material 23.

Next, the covering member 12 is applied so as to cover the fixing pins 8a and the connection terminals 2. In the case where the covering member 12 is formed of a thermosetting resin, the head base body 3 to which the covering member 12 is applied is placed on the radiator 1 on which a double-sided tape or the like is provided. Then, the covering member 12 is cured. The substrate 7 may be joined to the radiator 1 after the covering member 12 is cured, or the covering member 12 may be applied and cured after the substrate 7 is joined to the radiator 1. The thermal head X1 can be manufactured as described above.

Next, a thermal printer Z1 will be described referring to FIG. 8.

As shown in FIG. 8, the thermal printer Z1 according to this embodiment includes the above-mentioned thermal head X1, a conveying mechanism 40, a platen roller 50, a power source device 60, and a control device 70. The thermal head X1 is installed on the mounting face 80a of the mounting member 80 disposed on the housing (not shown) of the thermal printer Z1. The thermal head X1 is installed on the mounting member 80 along the main scanning direction which is orthogonal to the conveying direction of the recording medium P described later.

The conveying mechanism 40 has a drive section (not shown) and conveying rollers 43, 45, 47 and 49. The conveying mechanism 40 conveys the recording medium P such as heat sensitive paper or image receiving paper to which ink is transferred, in the direction of the arrow S shown in FIG. 8 onto the protection layer 25 located on the plurality of heat generating sections 9 of the thermal head Xl. The drive section has a function of driving the conveying rollers 43, 45, 47 and 49, and for example, a motor can be used as the drive section. The conveying rollers 43, 45, 47 and 49 can be configured by covering cylindrical shafts 43a, 45a, 47a and 49a made of a metal such as stainless steel, with elastic members 43b, 45b, 47b and 49b made of butadiene rubber or the like, for example. In the case where the recording medium P is, for example, image receiving paper to which ink is transferred, an ink film is conveyed together with the recording medium P between the recording medium P and the heat generating sections 9 of the thermal head X1.

The platen roller 50 has a function of pressing the recording medium P against the protection layer 25 located on the heat generating sections 9 of the thermal head X1. The platen roller 50 is disposed so as to extend in the direction orthogonal to the conveying direction S of the recording medium P, and both end portions thereof are supported and fixed so as to be rotatable in a state of pressing the recording medium P against the heat generating sections 9. The platen roller 50 can be configured, for example, by covering a cylindrical shaft 50a made of a metal such as stainless steel, with an elastic member 50b made of butadiene rubber or the like, for example.

The power source device 60 has a function of supplying a current for generating heat from the heat generating sections 9 of the thermal head X1 and a current for driving the drive ICs 11 as described above. The control device 70 has a function of supplying control signals for controlling the operations of the drive ICs 11 to the drive ICs 11 in order to selectively heat the heat generating sections 9 of the thermal head X1 as described above.

As shown in FIG. 8, in the thermal printer Z1, while the recording medium P is pressed against the heat generating sections 9 of the thermal head X1 by the platen roller 50 and is conveyed onto the heat generating sections 9 by the conveying mechanism 40, the heat generating sections 9 selectively generate heat by the power source device 60 and the control device 70, whereby predetermined printing is performed on the recording medium P. In the case where the recording medium P is, for example, image receiving paper, printing is performed on the recording medium P by thermally transferring the ink of the ink film (not shown) which is conveyed together with the recording medium P.

### Second Embodiment

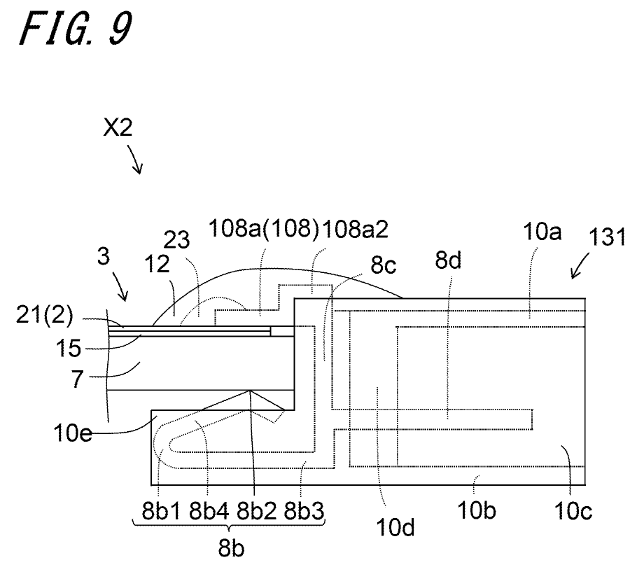

A thermal head X2 will be described referring to FIG. 9. The same members are designated by the same reference numerals and signs, and this is applied similarly to the following descriptions.

A connector pin 108 is different from the connector pin 8 in the shape of the fixing pin 108a thereof. The fixing pin 108a has a thick wall section 108a2 on the connection pin 8c side. In other words, the thickness of the portion of the fixing pin 108a on the connection pin 8c side is larger than the thickness of the portion of the fixing pin 108a on the substrate 7 side and the thickness of the fixing pin 108a changes intermittently.

Consequently, it is possible to improve the strength of the joining portion between the fixing pin 108a and the connection pin 8c. As a result, even in the case where a pressing force is exerted to the fixing pin 108a from below, it is possible to reduce the possibility that the fixing pin 108a may be broken.

The upper end of the fixing pin 108a is located above the highest portion of the housing 10. In other words, the upper end of the fixing pin 108a is provided higher than the side walls 10c. Even in this case, it is possible to improve the strength of the joint portion between the fixing pin 108a and the connection pin 8c.

### Third Embodiment

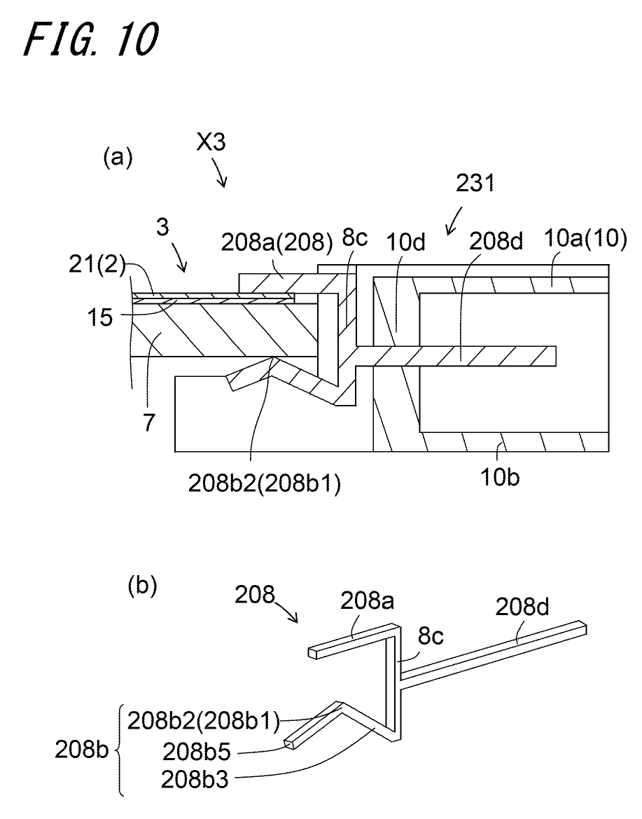

A thermal head X3 will be described referring to FIG. 10.

A connector 231 includes connector pins 208 and the housing 10. The connector pin 208 includes a fixing pin 208a, a movable pin 208b, the connection pin 8c and an extraction pin 208d. The fixing pin 208a has a constant thickness and is disposed on the connection terminal 2.

The movable pin 208b includes a movable section 208b1, a contact section 208b2, a first extension section 208b3 and a third extension section 208b5. The movable section 208b1 is formed into a bent shape and is configured so as to make contact with the lower face of the substrate 7. Hence, the connector pin 208 is configured so that the movable pin 208b1 also serves as the contact section 208b2. The first extension section 208b3 extends from the connection pin 8c toward the substrate 7 and is connected to the movable section 208b1. The third extension section 208b5 is disposed so as to extend from the contact section 208b2 toward the substrate 7. The extraction pin 208d is extracted from the central portion of the connection pin 8c in the thickness direction, and the extraction pin 208d is disposed above the contact section 208b2.

When the substrate 7 is inserted into the connector 231, the movable sections 208b1 of the movable pins 208b are deformed downwardly, whereby a clearance can be formed between the fixing pins 208a and the substrate 7. As a result, it is possible to reduce the possibility that the connection terminals 2 may be shaved when the substrate 7 is inserted, and to ensure the reliability of the electrical connection between the thermal head X1 and the outside.

In addition, the movable pin 208b includes the third extension section 208b5. Hence, the movable pin 208b can be deformed downwardly by bringing the substrate 7 into contact with the third extension section 208b5. As a result, the substrate 7 can be fitted into the connector 231 easily.

### Fourth Embodiment

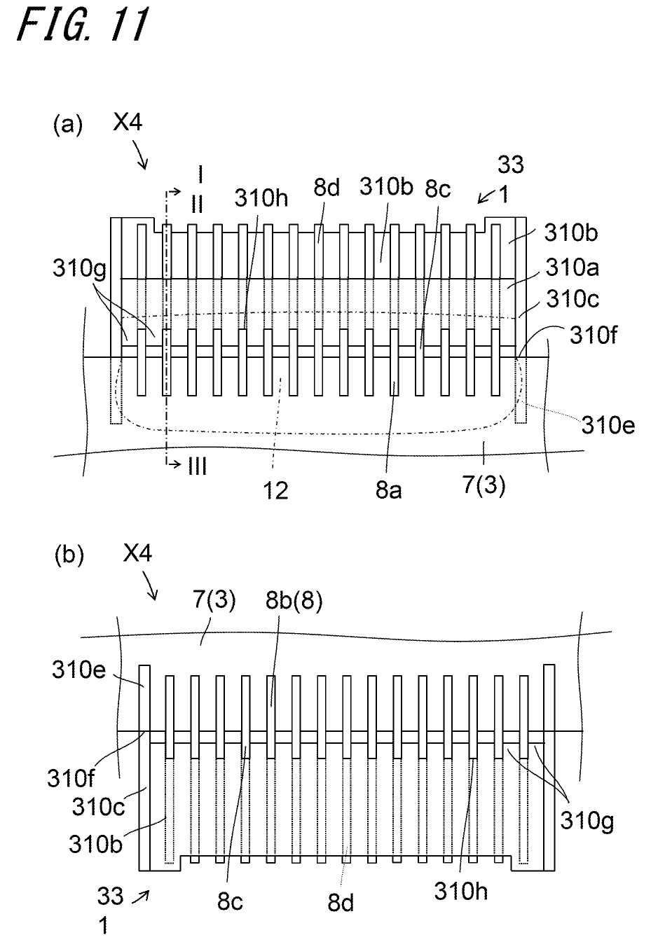

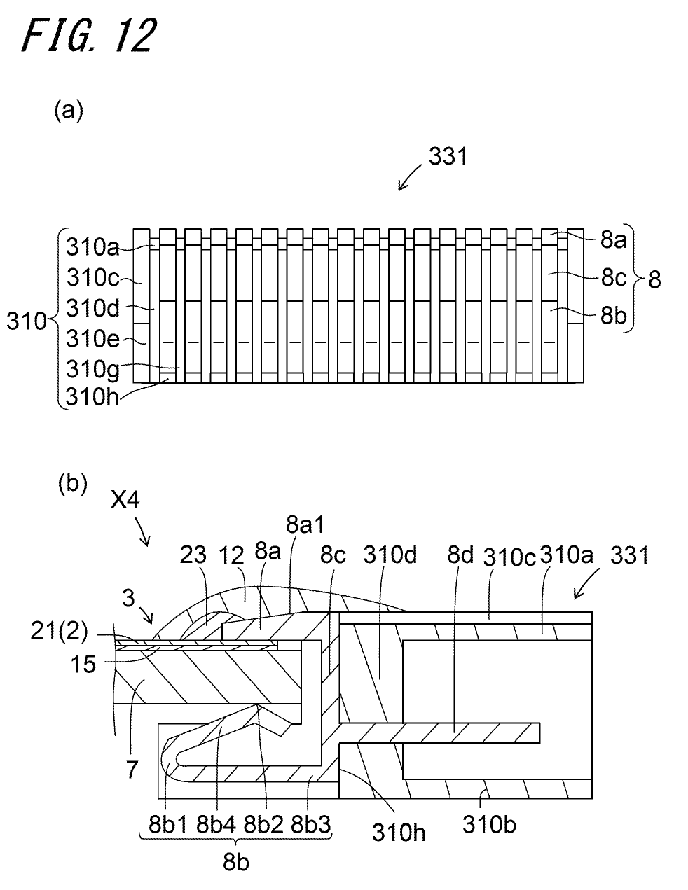

A thermal head X4 will be described referring to FIGS. 11 and 12.

A housing 310 includes an upper wall 310a, a lower wall 310b, side walls 310c, a front wall 310d, support sections 310e, positioning sections 310f, protruding sections 310g and groove sections 310h. The groove sections 310h are disposed so as to extend in the thickness direction of the substrate 7 while being mutually arranged at intervals in the main scanning direction. The protruding sections 310g are each formed between the groove sections 310h adjacent to each other. Similarly, the groove sections 310h and the protruding sections 310g are also formed on the upper wall 310a and the lower wall 310b.

The connection pin 8c of the connector pin 8 is disposed in the groove section 310h, and part of the connection pin 8c is disposed in the groove section 310h. Hence, it is possible to improve the strength of the fixing pin 8a connected to the connection pin 8c. Furthermore, the movable pin 8b is deformed about the connection pin 8c disposed in the groove section 310h, whereby the deformation of the movable pin 8b is less prone to be transmitted to the fixing pin 8a. As a result, it is possible to reduce the possibility that the fixing pin 8a may be separated from the connection terminal 2 (see FIG. 1).

Still further, since the connection pin 8c is disposed in the groove section 310h, part of the connection pin 8c is joined to the front wall 310d of the housing 310, and the connector pin 8 is joined to the housing 310. Hence, the connection pin 8c is fixed, and the movable pin 8b is deformed about the joining section between the connection pin 8c and the first extension section 8b3. As a result, when a pressing force is exerted to the movable pin 8b from above, the first extension section 8b3 thereof can be deformed downwardly, whereby the deformation amount of the movable pin 8b can be increased. For this reason, the substrate 7 can be inserted easily between the fixing pins 8a and the movable pins 8b, and the manufacturing efficiency can be improved.

Furthermore, since the connection pin 8c is disposed in the groove section 310h, the connector pin 8 is supported by the protruding sections 310g. As a result, even in the case where an external force is exerted to the housing 310 by connecting/disconnecting a cable, it is possible to reduce the possibility that the connector pins 8 may be separated from the housing 310.

In addition, the extraction pin 8d is disposed below the contact section 8b2. In other words, the connector pin 8 is fixed to the housing 310 at a position below the contact section 8b2 at which the substrate 7 makes contact with the movable pins 8b.

For this reason, the connection pin 8c which connects the extraction pin 8d to the movable pin 8b can be deformed, whereby the movable pin 8b is configured so as to be deformed more easily and the deformed movable pin 8b is configured so as to be less prone to protrude from the lower end of the housing 310. In other words, the movable pin 8b can be elastically deformed easily, and it is possible to reduce the possibility that the movable pin 8b may protrude from the housing 310. As a result, the substrate 7 can be inserted efficiently, and it is possible to reduce the possibility that the movable pins 8b may make contact with other components constituting the thermal head X4, such as the radiator 1.

### Fifth Embodiment

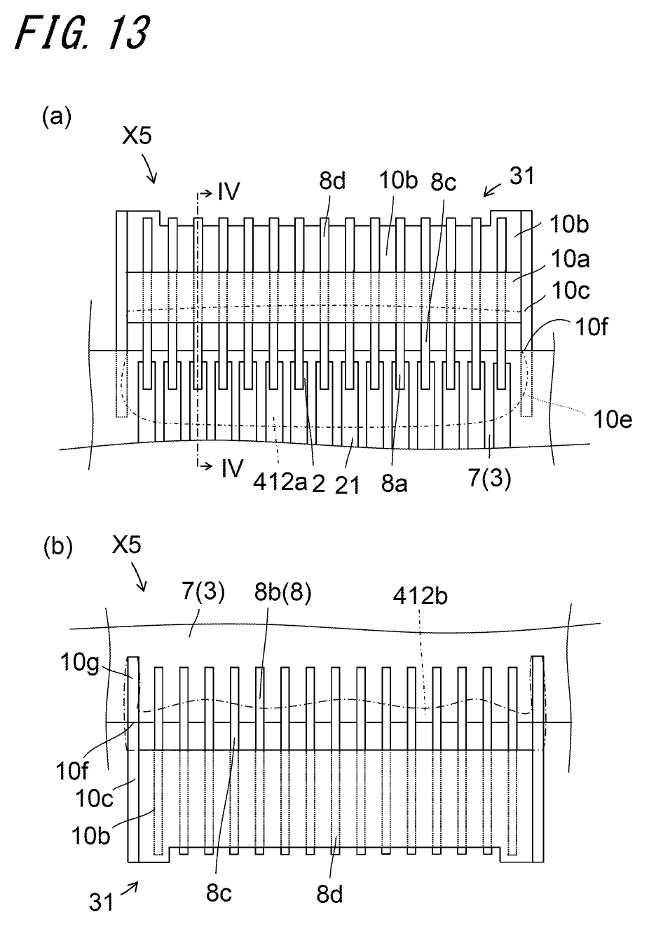

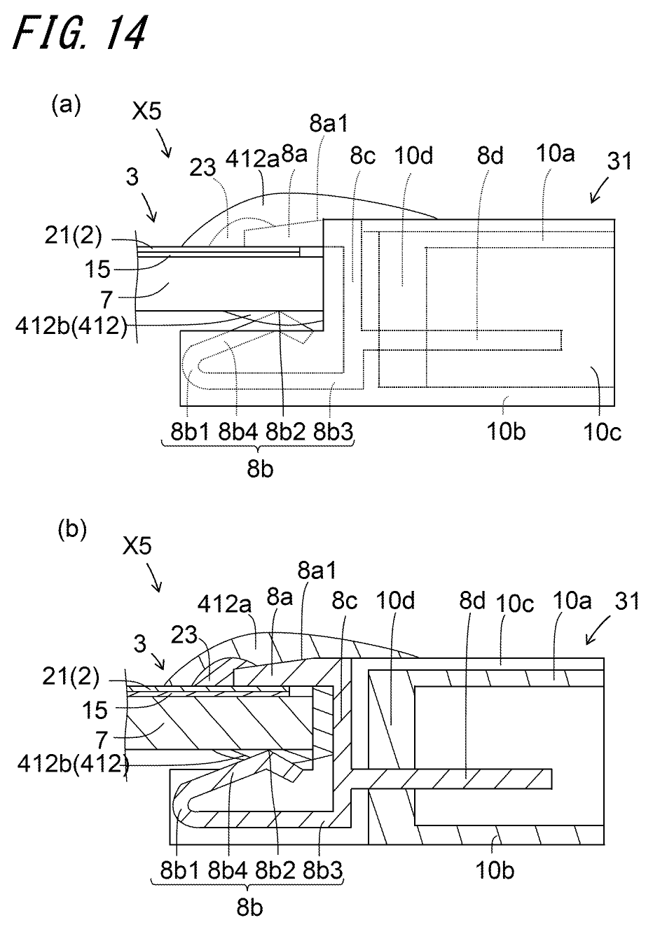

A thermal head X5 will be described referring to FIGS. 13 and 14. The covering member 412 of the thermal head X5 is different from the covering member 12 of the thermal head X1, but the thermal head X5 is the same as the thermal head X1 in the other respects.

The covering member 412 includes a first covering member 412a and a second covering member 412b. The first covering member 412a is disposed on the fixing pin 8a side so that the connection terminal 2 and the fixing pin 8a are not exposed to the outside. The second covering member 412b is disposed on the movable pin 8b side so that part of the movable pin 8b is exposed. Since the first covering member 412a and the second covering member 412b are disposed, it is possible to enhance the joining strength between the head base body 3 and the connector 31.

The first covering member 412a and the second covering member 412b can be formed of an epoxy-based thermosetting resin or an ultraviolet curing resin. The first covering member 412a and the second covering member 412b may be formed of the same material or may be formed of different materials,

In the thermal head X1 shown in FIG. 6, the fixing pin 8a is connected to the connection terminal 2 electrically and mechanically with the conductive joining material 23, whereby the joining between the fixing pin 8a and the connection terminal 2 is strong. On the other hand, the movable pin 8b makes contact with the substrate 7 only at the contact section 8b2, whereby the joining strength thereof to the substrate 7 is lower than that of the fixing pin 8a.

In addition, the connector pin 8 may be deformed in some cases when the housing 10 expands due to the heat generated during the driving of the thermal head X1. Since the fixing pin 8a is fixed to the connection terminal 2 with the conductive joining material 23 at the time, the movable pin 8b is liable to be deformed. As a result, the covering member 12 located around the movable pin 8b may be peeled in some cases.

On the other hand, the covering member 412 covers the fixing pin 8a part of the movable pin 8b and not to cover the remaining part of the movable pin 8b. Hence, even in the case where the housing 10 and the connector pin 8 expand due to heat, it is possible to ensure the degree of freedom of the movable pin 8b, and to reduce the binding force by the resin. Consequently, stress is less prone to be generated in the second covering member 412b located around the movable pin 8b.

As a result, it is possible to reduce the possibility that the second covering member 412b located around the movable pin 8b may be peeled, and to ensure the joining strength of the connector 31. Hence, it is possible to reduce the possibility that the connector 31 may be separated from the substrate 7.

Furthermore, the movable pin 8b includes the movable section 8b1, the contact section 8b2, the first extension section 8b3 and the second extension section 8b4, the first covering member 412a is disposed so as to cover the fixing pin 8a, the second covering member 412b is disposed so that part of the movable pin 8b is exposed, and the first extension section 8b3 is exposed from the second covering member 412b. Hence, even if the connector pin 8 is deformed so as to extend, since the first extension section 8b3 is deformed, it is possible to relieve the elongation occurring in the connector pin 8.

In other words, although the elongation of the connector pin 8 is transmitted from the fixing pin 8a to the movable pin 8b via the connection pin 8c, since the first extension section 8b3 functions as a portion for relieving the elongation of the connector pin 8, stress is less prone to be generated in the second covering member 412b located around the movable pin 8b. As a result, it is possible to reduce the possibility that the second covering member 412b may be peeled.

In addition, the second covering member 412b is disposed so as to cover the contact section 8b2. Hence, the second covering member 412b functions so as to join the substrate 7 to the contact section 8b2. As a result, the contact section 8b2 is not exposed, and it is possible to improve the joining strength between the substrate 7 and the connector 31.

In addition, a portion of the connection pin 8c on the fixing pin 8a side is covered with the first covering member 412a, and a portion of the connection pin 8c on the movable pin 8b side is exposed from the second covering member 412b. Hence, the portion of the connection pin 8c on the movable pin 8b side exposed from the second covering member 412b can be deformed freely. As a result, the connection pin 8c can be deformed so as to relieve the elongation of the connector pin 8. For this reason, stress is less prone to be generated in the second covering member 412b disposed around the contact section 8b2 of the movable pin 8b, and it is possible to reduce the possibility that the second covering member 412b may be peeled.

The portion of the connection pin 8c on the fixing pin 8a side represents the region ranging from 15 to 25% in the extension direction length of the connection pin 8c from the end portion of the connection pin 8c to which the fixing pin 8a is connected, and the portion of the connection pin 8c on the movable pin 8b side represents the region ranging from 15 to 25% in the extension direction length of the connection pin 8c from the end portion of the connection pin 8c to which the movable pin 8b is connected.

Still further, the first covering member 412a preferably seals the fixing pin 8a or the contact section 8b2. In the case where the first covering member 412a seals the fixing pin 8a or the contact section 8b2, it is possible to enhance the sealability of the fixing pin 8a and to improve the joining strength of the contact section 8b2.

### Sixth Embodiment

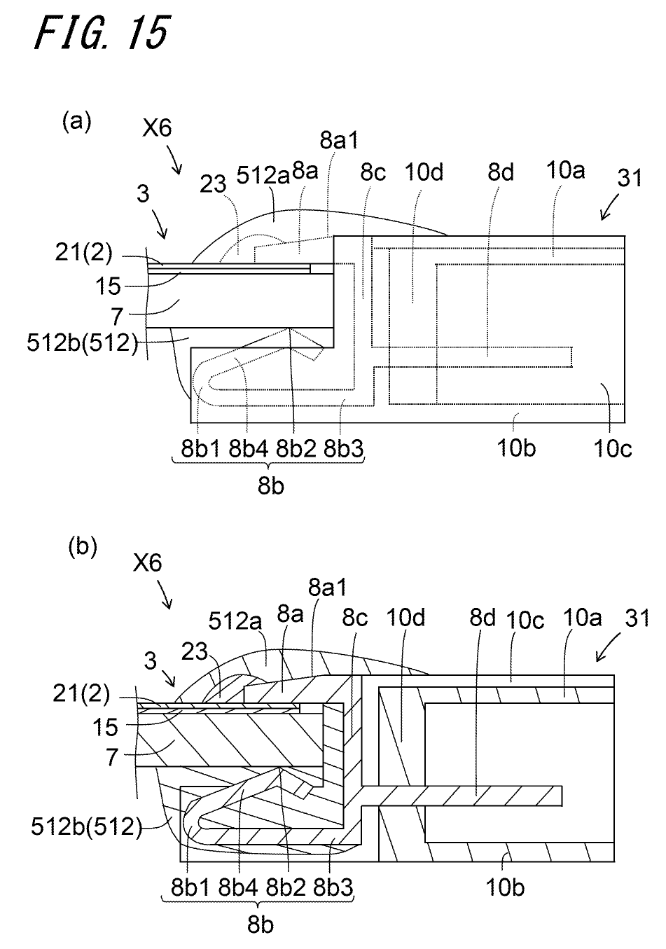

A thermal head X6 will be described referring to FIG. 15. The covering member 512 of the thermal head X6 is different from the covering member 12 of the thermal head X1, but the thermal head X6 is the same as the thermal head X1 in the other respects.

The covering member 512 of the thermal head X6 includes a first covering member 512a and a second covering member 512b. The first covering member 512a is disposed on the fixing pin 8a, and the second covering member 512b is disposed on the movable pin 8b. The first covering member 512a is disposed so as to seal the fixing pin 8a as shown in FIG. 15(a). The second covering member 512b is disposed so as to seal the movable pin 8b as shown in FIG. 15(b). Furthermore, the hardness of the second covering member 512b is made smaller than that of the first covering member 512a.

The first covering member 512a can be formed of, for example, an epoxy-based thermosetting resin, and the Shore D hardness thereof is preferably D80 to 100. Furthermore, the thermal expansion coefficient thereof is preferably 10 to 20 ppm at normal temperature.

The second covering member 512b can be formed of, for example, an epoxy-based thermosetting resin, and the Shore D hardness thereof is preferably D60 to 80. Furthermore, the thermal expansion coefficient thereof is preferably 60 to 100 ppm at normal temperature.

The hardness values of the first covering member 512a and the second covering member 512b can be measured using, for example, a JIS K 6253 durometer (type D). For example, the hardness values at three arbitrary points on the first covering member 512a are measured using the durometer, and the average of the values is calculated and can be set as the hardness of the first covering member 512a. The hardness of the second covering member 512b can also be obtained similarly. Instead of the durometer, a Shore hardness meter or the like may also be used for the measurement.

In the thermal head X6, the hardness of the second covering member 512b is lower than that of the first covering member 512a. Hence, even in the case where thermal expansion occurs in the connector pin 8, the second covering member 512b can follow the deformation of the movable pin 8b because the hardness of the second covering member 512b located around the movable pin 8b is low.

As a result, it is possible to relieve the stress generated inside the second covering member 512b and to reduce the possibility that the second covering member 512b may be peeled, whereby it is possible to ensure the joining strength of the connector 31. Hence, it is possible to reduce the possibility that the connector 31 may be separated from the substrate 7.

In addition, the thermal expansion coefficient of the second covering member 512b is preferably larger than that of the first covering member 512a. Thereby, the second covering member 512b can follow the deformation of the movable pin 8b. As a result, it is possible to relieve the stress generated inside the second covering member 512b due to the elongation of the connector pin 8.

The thermal expansion coefficient of the second covering member 512b, however, is not necessarily required to be larger than that of the first covering member 512a.

Although the embodiments according to the invention have been described above, the invention is not limited to the above-mentioned embodiments, but various modifications are possible without departing from the scope of the invention. For example, the thermal printer Z1 incorporating the thermal head X1 according to the first embodiment has been described, but without being limited to this, the thermal heads X2 to X6 may be used for the thermal printer Z1. Moreover, the thermal heads X1 to X6 according to the plurality of embodiments may be combined.

Although the example in which the connector 31 is disposed at the central portion in the arrangement direction is taken in the descriptions of the thermal heads X1 to X6, the connectors may be disposed at both end portions in the arrangement direction.

In addition, without forming the protruding section 13b on the heat storage layer 13, the heat generating sections 9 of the electric resistance layer 15 may be disposed on the base section 13a of the heat storage layer 13. Furthermore, the heat storage layer 13 may be disposed over the entire region of the upper face of the substrate 7.

Furthermore, the heat generating sections 9 may be configured by forming the common electrode 17 and the individual electrodes 19 on the heat storage layer 13 and by forming the electric resistance layer 15 only in the region between the common electrode 17 and the individual electrodes 19.

Still further, although the thin-film head including the heat generating sections 9 which are small in thickness by performing thin film formation of the electric resistance layer 15 has been described as an example, the head is not limited to this head. For example, the invention may be applied to a thick-film head including the heat generating sections 9 which are large in thickness by performing thick film formation of the electric resistance layer 15. Furthermore, this technology may be used for an end-face head in which the heat generating sections 9 are formed on the end face of the substrate.

The covering member 12 and the hard coat 29 which covers the drive ICs 11 may be made of the same material. In such a case, the hard coat 29 and the covering member 12 may be formed simultaneously by printing the hard coat 29 in the region in which the covering member 12 is formed at the time of printing the hard coat 29.

### REFERENCE SIGNS LIST

X1-X6: Thermal head

Z1: Thermal printer

1: Radiator

2: Connection terminal

3: Head base body

4: Ground electrode

7: Substrate

8: Connector pin

8a: Fixing pin

8b: Movable pin

8b1: Movable section

8b2: Contact section

8b3: First extension section

8b4: Second extension section

8c: Connection pin

8d: Extraction pin

9: Heat generating section

10: Housing

10a: Upper wall

10b: Lower wall

10c: Side wall

10d: Front wall

10e: Support section

10f: Positioning section

10g: Protruding section

11: Drive IC

12: Covering member

13: Heat storage layer

15: Electric resistance layer

17: Common electrode

19: Individual electrode

21: IC-connector connection electrode

23: Conductive joining material

25: Protection layer

26: IC-IC connection electrode

27: Covering layer

29: Hard coat

1. A thermal head, comprising:
a substrate,
a heat generating section disposed on the substrate,
an electrode which is disposed on the substrate and is electrically connected to the heat generating section, and
a connector comprising a fixing pin electrically connected to the electrode, a movable pin which holds the substrate between the movable pin and the fixing pin, and a connection pin which connects the fixing pin to the movable pin,
the movable pin comprising a movable section which is bent or curved and a contact section making contact with the substrate,
the movable pin being disposed so as to protrude from the connection pin beyond the fixing pin, and
the contact section being located closer to a connection pin side than a tip end of the fixing pin.

2. The thermal head according to claim 1, wherein the fixing pin includes a thick wall section on a connection pin side.

3. The thermal head according to claim 1, wherein the fixing pin has an inclined region whose thickness becomes larger toward the connection pin.

4. The thermal head according to claim 1,
wherein the connector further comprises a housing, and
part of the connection pin is joined to the housing.

5. The thermal head according to claim 1,
wherein the connector further comprises a housing, and
an upper end of the fixing pin is located below a highest portion of the housing.

6. The thermal head according to claim 4,
wherein the connector further comprises an extraction pin extracted from the connection pin, and
part of the extraction pin is joined to the housing at a position lower than the contact section.

7. The thermal head according to claim 1,
wherein the movable pin includes a first extension section which extends from the connection pin toward the substrate and is connected to the movable section, and a second extension section which extends from the movable section toward the connection pin and is connected to the contact section.

8. The thermal head according to claim 1, further comprising a covering member disposed on the fixing pin and the movable pin,
wherein the covering member is disposed so as to cover the fixing pin and part of the movable pin and not to cover a remaining part of the movable pin.

9. The thermal head according to claim 7, further comprising a covering member disposed on the fixing pin and the movable pin,
wherein the covering member is disposed so as to cover the fixing pin and part of the movable pin and not to cover a remaining part of the movable pin, and
the first extension section is exposed from the covering member.

10. The thermal head according to claim 8, wherein the contact section is covered with the covering member.

11. The thermal head according to claim 8, wherein a portion of the connection pin on a fixing pin side is covered with the covering member and a portion of the connection pin on a movable pin side is not covered with the covering member.

12. The thermal head according to claim 8,
wherein the covering member includes a first covering member disposed on a fixing pin side, and a second covering member disposed on a movable pin side, and
a hardness of the second covering member is lower than that of the first covering member.

13. The thermal head according to claim 1, further comprising:
a first covering member disposed on the fixing pin and
a second covering member disposed on the movable pin,
wherein a hardness of the second covering member is lower than that of the first covering member.

14. A thermal printer, comprising:
the thermal head according to claim 1,
a conveying mechanism which conveys a recording medium onto the heat generating section and
a platen roller which presses the recording medium against the heat generating section.

15. (canceled)

16. A thermal head, comprising:
a substrate,
a heat generating section disposed on the substrate,
an electrode which is disposed on the substrate and is electrically connected to the heat generating section,
a connector comprising a fixing pin electrically connected to the electrode, a movable pin which holds the substrate between the movable pin and the fixing pin, and a connection pin which connects the fixing pin to the movable pin, and
a covering member disposed on the fixing pin and the movable pin,
wherein the covering member is disposed so as to cover the fixing pin and part of the movable pin and not to cover a remaining part of the movable pin.

17. The thermal head according to claim 16,
wherein the movable pin comprising a movable section which is bent or curved and a contact section making contact with the substrate,
wherein the covering member is disposed so as to cover the fixing pin and part of the movable pin and not to cover a remaining part of the movable pin.

18. A thermal printer, comprising:
the thermal head according to claim 16,
a conveying mechanism which conveys a recording medium onto the heat generating section and
a platen roller which presses the recording medium against the heat generating section.

19. A thermal head, comprising:
a substrate,
a heat generating section disposed on the substrate,
an electrode which is disposed on the substrate and is electrically connected to the heat generating section,
a connector comprising a fixing pin electrically connected to the electrode, a movable pin which holds the substrate between the movable pin and the fixing pin, and a connection pin which connects the fixing pin to the movable pin,
a first covering member disposed on the fixing pin, and
a second covering member disposed on the movable pin,
wherein a hardness of the second covering member is lower than that of the first covering member.

20. The thermal head according to claim 19,
wherein a thermal expansion coefficient of the second covering member is lower than a thermal expansion coefficient of the first covering member.

21. A thermal printer, comprising:
the thermal head according to claim 19,
a conveying mechanism which conveys a recording medium onto the heat generating section and
a platen roller which presses the recording medium against the heat generating section.
